(19) United States
(12) Patent Application Publication
(10) Pub. No.: US 2025/0038625 A1
(43) Pub. Date: Jan. 30, 2025

(54) METHOD FOR DETECTING THE POSITION OF A ROTOR ELEMENT, COMPUTER PROGRAM PRODUCT, AND SENSOR DEVICE

(71) Applicant: HELLA GmbH & Co. KGaA, Lippstadt (DE)

(72) Inventor: Nils LABAHN, Lippstadt (DE)

(73) Assignee: HELLA GmbH & Co. KGaA, Lippstadt (DE)

(21) Appl. No.: 18/913,214

(22) Filed: Oct. 11, 2024

Related U.S. Application Data
(63) Continuation of application No. PCT/EP2023/058452, filed on Mar. 31, 2023.

(30) Foreign Application Priority Data
Apr. 11, 2022 (DE) 10 2022 108 718.2

(51) Int. Cl. H02K 11/225

(52) U.S. Cl. CPC H02K 11/225

(57) ABSTRACT

A method for detecting the position of a rotor element on the basis of a sensor signal of a sensor unit in order to detect a first angular position of the rotor element. The angular position relating to a repeating sub-section of a rotation of the rotor element within a rotational range. A computer program product and a sensor device are also provided.

This nonprovisional application is a continuation of International Application No. PCT/EP2023/058452, which was filed on Mar. 31, 2023, and which claims priority to German Patent Application No. 10 2022 108 718.2, which was filed in Germany on Apr. 11, 2022, and which are both herein incorporated by reference.

### BACKGROUND OF THE INVENTION

### Field of the Invention

The invention relates to a method for detecting a rotor position of a rotor element as a function of a sensor signal of a sensor unit, a computer program product, and a sensor device.

### Description of the Background Art

The use of sensors as MPS (motor position sensors) is known from the prior art. To a certain extent, the sensors should not be mounted on the end of a shaft but rather more or less surround the electric motor or a shaft. This requires sensors which have a large diameter.

It is known from EP 0 909 955 B1, which corresponds to U.S. Pat. No. 6,236,199, which is incorporated herein by reference, to provide sensors with a segment-like design.

In the conventional art, however, the sensors make it possible for the target to rotate completely, the output signals of the sensors are frequently not clear over 360°, but rather are allowed to repeat. However, additional faults occur in segmented sensors of this type, due to mechanical tolerances. In addition, the present angular position of the target may be unknown after a restart of the sensors and/or the electronics.

### SUMMARY OF THE INVENTION

It is therefore an object of the present invention to at least partially eliminate above disadvantages known from the prior art. In particular, an object of the present invention is to improve the accuracy when detecting a rotor position of a rotor element.

Features and details which are described in connection with a method according to the invention also apply, of course, in connection with a computer program product according to the invention and/or a sensor device according to the invention, and vice versa in each case, so that reference always is or may be made interchangeably with respect to the disclosure of the individual aspects of the invention.

According to a first aspect of the invention, a method is provided for detecting a rotor position of a rotor element as a function of a sensor signal of a sensor unit in order to detect a first angular position of the rotor element. The first angular position relates to a repeating subsection of a rotation of the rotor element within a rotational range. The method comprises, in particular in the form of method steps: determining the first angular position of the rotor element as a function of the sensor signal, in particular by a computing unit; sensing a piece of position information for localizing the first angular position in the rotational range, in particular by the computing unit; ascertaining a piece of error information of an expected angle error as a function of the first angular position and the position information, in particular by the computing unit; and determining, preferably calculating, the rotor position of the rotor element relating to the rotational range as a function of the error information, in particular by the computing unit.

The rotor element may be, for example, part of a motor, preferably an electric motor. The rotor element may be, for example, an axle or a shaft. The rotor position may be understood to be a rotational position of the rotor element, preferably in relation to a specified zero position. The zero position may be defined, in particular, by the rotor element and/or the sensor unit. The zero position may furthermore be mechanically and/or electronically predefined. The rotor position may thus relate, in particular, to the entire rotational range. By taking into account the angle error, the rotor position may preferably also be referred to as an adjusted, absolute angular position of the rotor element.

The sensor unit can be designed as a motor position sensor (MPS). The sensor unit may be designed, in particular, for the contactless detection of the first angular position. A wear of components of the sensor unit and/or the rotor element may be reduced thereby.

The sensor signal may be a continuous or discontinuous and/or a digital or analog signal. It is further conceivable that the sensor signal comprises a singular signal, by means of which only one individual value of the first angular position is transmitted. The first angular position and/or the rotor position may thus be determined as a single point and/or as a course. When determining the first angular position, the first angular position may be calculated on the basis of the sensor signal. For example, the sensor signal may be transformed and/or sampled to determine the first angular position. However, it is also conceivable that the sensor signal comprises a piece of information about the first angular position.

The subsection may comprise, for example, a predefined angle range, which may be detected by the sensor unit. The subsection may thus also be referred to as the measurement range. The first angular position may comprise an, in particular, rotational position of the rotor element in the subsection, measured with the aid of the angle error. In particular, the first angular position may therefore be also referred to as a relative, measured angular position. The repetition of the subsection may be understood to be that the angle range is provided multiple times in the rotational range. For example, if the rotor element leaves a subsection, it may be provided that the angle range is repeated, i.e., in particular, the subsection is restarted.

The position information may be preferably detected as a signal. For example, the position information may be provided externally, for example by a component external to the system. The position information is preferably related to the rotational range. The position information may have a lower accuracy than the sensor signal and/or the determination of the first angular position. For example, the position information may comprise a number of full rotations of the rotational element already completed and/or a partial rotation already completed, in particular from the zero position. In particular, the first angular position may be unclear in relation to the rotational range, due to the relation to the repeating subsection. Due to the position information, the first angular position may be preferably clearly assigned in relation to the rotational range.

The expected angle error may be a periodic, for example sinusoidal, error. The expected angle error may become or be determined as a single point and/or as a course. The expected angle error has, in particular, a correlation to the first angular position and the position information and/or the localization of the first angular position in the rotational range. The position information makes it possible to infer the positioning of the first angular position in the rotational range, based on which the expected angle error may be determined.

The error information can comprise a, for example, predetermined value of the expected angle error. However, it is also conceivable that the error information comprises the assigned rotor position, in particular a value of the rotor position assigned to the first angular position, as a function of the position information.

The determination of the rotor position may take place as a function of the angle error and the first angular position. For example, the first angular position by be corrected by the angle error. It may be provided that the rotor position is provided for an actuation of the rotor element. For example, an electric motor may be actuated on the basis of the rotor position.

The accuracy when detecting the rotor position may thus be further improved beyond the subsection by taking into account the angle error even if the sensor unit may detect only the subsection. The sensor unit may be provided with a compact and economical design thereby and, at the same time, detect the rotor position in the, in particular entire, rotational range, taking the expected angle error into account. For example, a more precise actuation of the rotor element may take place, due to the improved accuracy.

In a method according to the invention, it is further conceivable that, to ascertain the error information, as a function of the first angular position and the position information, a second angular position is determined, which relates to the rotational range of the rotor element, in particular, the rotor position being determined as a function of the second angular position and, in particular, the error information. The second angular position may thus relate, in particular, to the entire rotational range. The second angular position may comprise an, in particular, rotational position of the rotor element in the rotational range, measured with the aid of the angle error. The first angular position may thus be transferred to the rotational range, based on the position information. In particular, the second angular position may therefore be also referred to as an absolute measured angular position. It is conceivable that a sum and/or difference of the second angular position and the angle error is/are formed when determining the rotor position, as a function of the second angular position.

In a method according to the invention, it is furthermore conceivable that the rotational range is divided into multiple angle segments, the first angular position being localized in one of the angle segments as a function of the sensing of the position information. In particular, the rotational range may correspond to an integral multiple of the angle segments. The first angular position may thus also be referred to as a segment-based angular position. The subsection preferably repeats in each of the angle segments. Each of the angle segments may have a segment size which comprises a size of the subsection or corresponds to a size of the subsection. The position information preferably has a tolerance, which is less than half the subsection. A position of the particular angle segments in the rotational range may be assigned to each angle segment. One of the angle segments, in which the first angular position is located, may be identified thereby, in particular, with a sufficient accuracy, based on the position information. The error information and the rotor position may be determined based on the angle segment and the position of the rotor element described via the first angular position in the angle segment.

In a method according to the invention, it may be advantageously provided that a sensing of the sensor signal and/or the determination of the first angular position takes place over the angle segments, preferably continuously, a course of the second angular position, in particular, being determined as a function of the angle segments and a course of the first angular position. The continuous sensing of the sensor signal may take place steadily and/or discretely. For example, the sensor signal may be continuously present in the form of a changing electrical voltage or provide a piece of information about the first angular position at regular intervals. It may be provided that the angle error is also determined in the form of a course as a function of the course of the first and/or second angular position. It may be sufficient if the position information is detected, in particular on a one-time basis, upon starting the rotation of the rotor element and/or upon starting the sensor device. After receiving the position information, the course of the second angular position may be calculated as a function of the course of the first angular position, for example, in that the angle segment assigned to the presently determined first angular position in each case is updated continuously. It is therefore not necessary to continuously detect the position information.

In a method according to the invention, it may be provided that, to ascertain the error information, the error information is taken from a database, which comprises the rotor position and/or the second angular position for multiple entries for the sensor signal, with a predetermined piece of error information about the angle error assigned in each case. When ascertaining the error information, the database may be searched for the latest first and/or second angular position, and the assigned error information may be taken, in particular called up. The database may be integrated into an internal memory unit of the sensor device and/or an external server. The first and second angular positions may be stored discretely in the database. In particular, the database may comprise a table, preferably in the form of a lookup table (LUT). The error information may be easily found thereby, and complex calculations of the error may be avoided. The error information may be correctly assigned across multiple angle segments by the position information.

In a method according to the invention, it is furthermore conceivable that a calibration process is carried out, in which the expected angle error is ascertained over the rotational range, and the pieces of error information are entered into the database. Due to the calibration process, the pieces of error information may thus be predetermined over multiple angle segments and/or the entire rotational range. The calibration process may be carried out, for example, immediately after an assembly of the sensor unit with the rotor element. For example, the calibration process may be carried out as part of an end-of-line (EOL) tester. Manufacturing- and assembly-related angle errors may be stored in the database thereby and called up at a later point in time as error information. In particular, an error distribution of the angle error over the rotational range may be sensed by the calibration process.

In a method according to the invention, it may preferably be provided that the sensor unit is designed as an inductive sensor, in particular, the sensor unit comprising a conductor unit which is rotatably fixedly connected to the rotor element, and a sensor element for the inductive sensing of the conductor element for detecting the first angular position. The conductor element is, in particular, electrically conductive. Based on the sensor principle, it is not necessary to design the sensor element as a full circle, due to the design of the sensor unit as an inductive sensor. In particular, the sensor element may be designed to detect only the subsection. The conductor element may be provided with an annular design and/or have a pattern-like structure, by means of which the angle segments are formed. For example, the structure may comprise radially running recesses and/or projections. The conductor element may circumferentially surround the rotor element, preferably surround its entire circumference. An assembly of the sensor unit may be simplified and economical thereby.

In a method according to the invention, it is also conceivable that the rotational range comprises a complete rotation of the rotor element around a rotation axis, in particular, a piece of error information of the expected angle error being able to be determined for each first and/or second angular position within the rotational range. The error information may be provided as a function and/or as a course, for example via the database. The error information may furthermore be determined with a predefined tolerance. For example, it may be provided that the pieces of error information are provided in a mathematically discrete manner. An abrupt change, for example, may be provided between two adjacent database entries with pieces of error information. Due to a large number of pieces of error information, the entire rotational range may still be covered to be able to determine a corresponding rotor position in each case. It is furthermore conceivable that an angle error is interpolated between two database entries.

In a method according to the invention, it may preferably be provided that, when sensing the position information, a position signal is obtained from a further sensor system, and/or the position information is called up from a memory unit. The further sensor system may, for example, comprise an acceleration sensor. The position information may also be stored in the memory unit, for example, when switching off the sensor device and/or the control unit and be called up upon a restart. This allows the position information to be made available initially when the determination of the first angular position takes place.

In a method according to the invention, it may furthermore be advantageously provided that, up to the sensing of the position information, an initialization process takes place, in which the rotor position is calculated as a function of the first angular position, the ascertainment of the error information taking place only after the completion of the initialization process. The completion of the initialization process may take place, for example, by the sensing of the position information. In particular, it may be provided that the ascertainment of the error information of the expected angle error does not take place during the initialization process. The position information may be still unknown or not yet be present during the initialization process. It has been recognized within the scope of the present invention that, if the position information is still unknown, the rotor position may take place as a function of the first angular position without taking into account the error information having a smaller statistical error. The error information is therefore preferably taken into account only after the completion of the initialization process and/or after the sensing of the position information, which facilitates a clear assignment of the first angular position in the rotational range. It may be provided that a switchover from the initialization process to a normal operation is carried out when the position information is present. During normal operation, the error information may be ascertained, and the rotor position may be taken into account when determining the rotor position.

In a method according to the invention, it is furthermore conceivable that the rotor element is a shaft of a vehicle. The shaft may be designed to drive the vehicle or a component of the vehicle. For example, the shaft may be designed as the output shaft of a motor, in particular, an electric motor. The number of angle segments may match a number of pole pairs of the electric motor. A commutation of the motor may be advantageously made possible thereby.

A computer program product can be provided according to a further aspect of the invention. The computer program product comprises commands, which, when executed by a control unit, prompt the control unit to carry out a method according to the invention.

The computer program product according to the invention thus involves the same advantages as those already described in detail with reference to a method according to the invention. The method may be, in particular, a computer-implemented method. The computer program product may be implemented as computer-readable machine code. The computer program product may also be stored on a computer-readable storage medium, such as a data disk, a removable drive, a volatile or non-volatile memory, or a built-in memory/processor. The computer program product may furthermore be made providable or be provided on a network, for example the Internet, from which it may be downloaded or executed online as needed by a user. The computer program product may be implemented with the aid of software as well as with the aid of one or multiple special electronic circuits, i.e., in hardware or in an arbitrary hybrid form, i.e., with the aid of software components and hardware components.

According to a further aspect of the invention, a sensor device is provided for detecting a rotor position of a rotor element in a rotational range. The sensor device includes a sensor unit for detecting a first angular position of a rotor element, which relates to a subsection of a rotational range of the rotor element. The sensor device furthermore comprises a control unit for carrying out a method according to the invention.

A sensor device according to the invention thus involves the same advantages as those already described in detail with reference to a method according to the invention and/or a computer program product according to the invention. The sensor device may be designed, for example, to be integrated into a vehicle and/or into a motor. The control unit may be integrated into a central control device of the vehicle, for example, in the form of an ECU and/or an engine control device. However, it is also conceivable that the control unit is integrated into a decentralized control assembly for the sensor unit. The control unit may comprise a processor and/or a microprocessor. The control unit may, in particular, also be referred to as a computing unit. The control unit may further include a memory unit for providing the database.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a method according to the invention with a schematic representation of method steps;

FIG. 2 shows a sensor device according to the invention for carrying out the method;

FIG. 3 shows a course of a first angular position in the method;

FIG. 4 shows a course of a second angular position in the method;

FIG. 5 shows a database for ascertaining a piece of error information in the method; and

FIG. 6 shows a method according to the invention with a schematic representation of method steps in a further exemplary embodiment.

### DETAILED DESCRIPTION

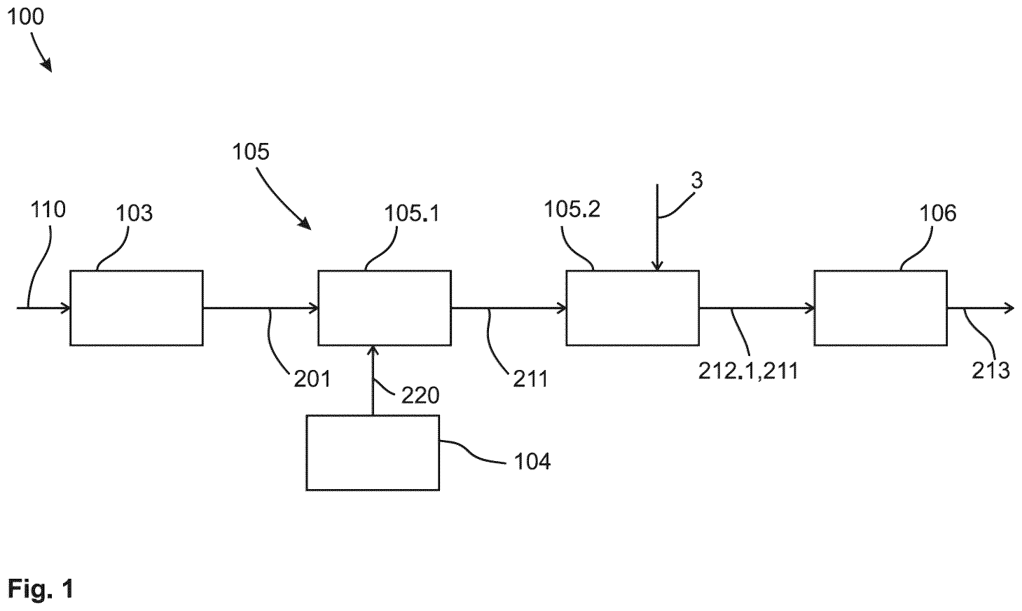

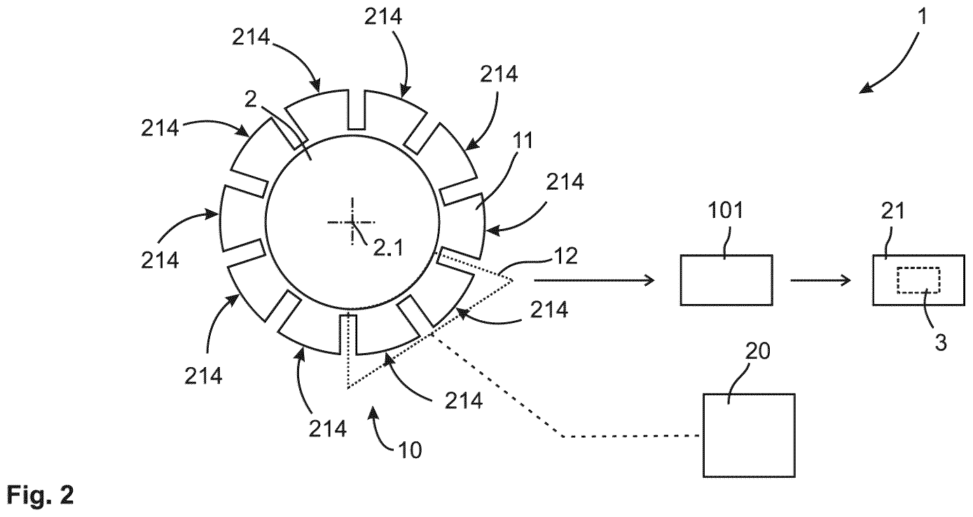

FIG. 1 shows a method 100 according to the invention for detecting a rotor position 213 of a rotor element 2 as a function of a sensor signal 110 of a sensor unit 10 for detecting a first angular position 201 of rotor element 2. Sensor unit 10 is preferably part of a sensor device 1, as illustrated in FIG. 2. Sensor device 1 includes sensor unit 10 and a control unit 20 for carrying out method 100. It is conceivable that rotor element 2 is a shaft, in particular of an electric motor, of a vehicle. Control unit 20 may be, for example, part of a central control device of the vehicle. In particular, method 100 may be carried out by a computer program product, which comprises commands, which, when executed by control unit 20, prompt control unit 20 to carry out method 100.

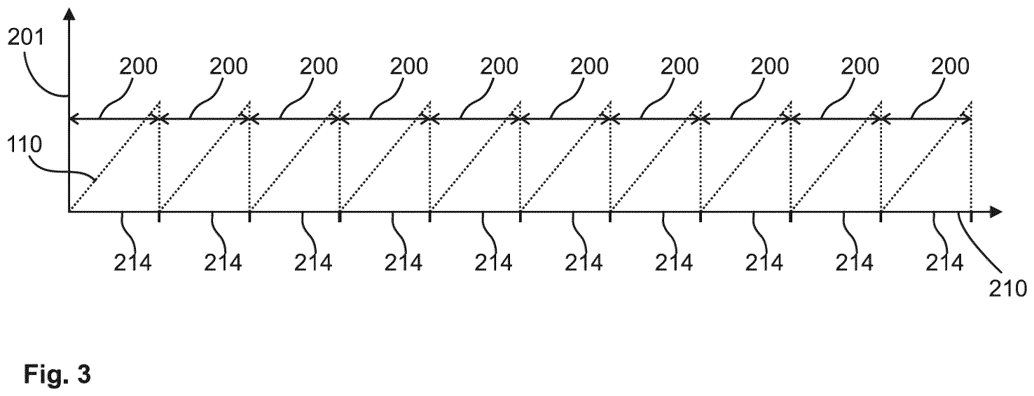

As illustrated in FIG. 2, sensor unit 10 is preferably designed as an inductive sensor. For this purpose, sensor unit 10 includes a conductor element 11, which is rotatably fixedly connected to rotor element 2. Conductor element 11 may surround the entire circumference of rotor element 2. Sensor unit 10 furthermore includes at least one sensor element 12 for the inductive sensing of connector element 11 for detecting first angular position 201. Conductor element 11 is, in particular, an electrical conductor, whose movement or movement change may be inductively detected by sensor element 12. Conductor element 11 may be provided with an annular design and/or have a pattern-like structure, by means of which angle segments 214 are defined, into which rotational range 210 is divided. Sensor element 12 is designed, in particular, to detect only a repeating subsection 200 of a rotation of rotor element 2 within a rotational range 210, as illustrated in FIG. 3. Subsection 200 corresponds, in particular, to one or multiple angle segments 214. Rotational range 210 forms the, in particular entire, angle section around a rotation axis 2.1 of rotor element 2, around which rotor element 2 may rotate. Rotational range 210 preferably comprises a complete rotation of rotor element 2 around rotation axis 2.1. Sensor signal 110 and thus first angular position 201 relate to repeating subsection 200. In particular, sensor signal 110 and first angular position 201 have an angle error 212.

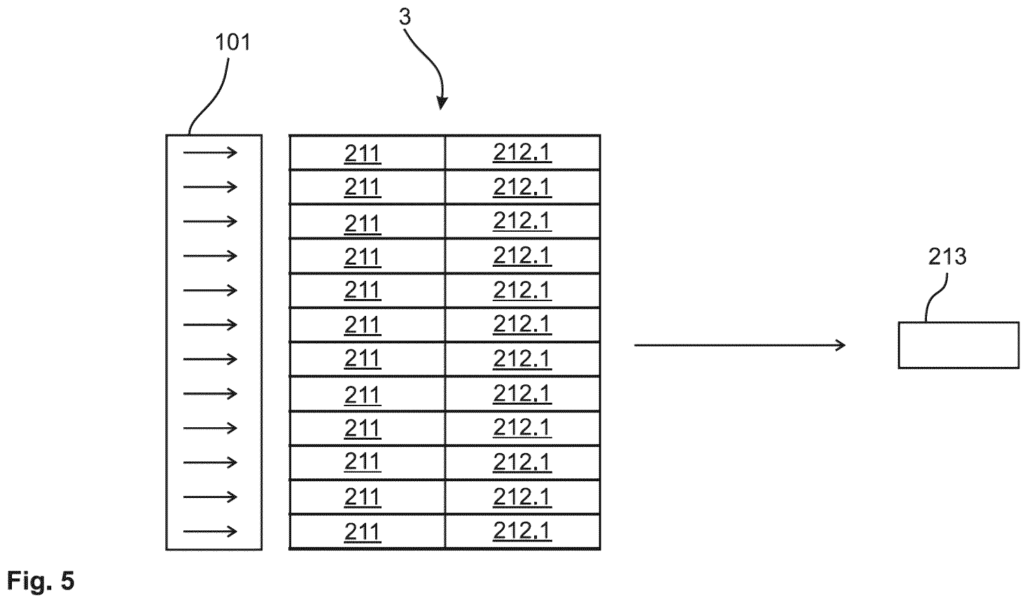

Angle error 212 may be manufacturing-related and/or be due to the assembly of conductor element 11 and take on different values, for example, over a course of first angular position 201 and also over angle segments 214. For example, angle error 212 may run periodically over rotational range 210. To sense angle error 212, a calibration process 101 may be carried out, in particular after assembly, in which an expected angle error 212 is ascertained over rotational range 210, and pieces of error information 212.1 about expected angle error 212 are entered in a database 3. As illustrated in FIG. 5, multiple entries for rotor position 213, sensor signal 110, and/or a second angular position 211, which relates to rotational range 210, may be stored in database 3 with a predetermined piece of error information 212.1 about angle error 212 assigned in each case. Database 3 may be preferably integrated into a memory unit 21 of sensor device 1 to facilitate a direct assignment of database 3 to the assembled arrangement of components.

As illustrated in FIG. 1, a determination 103 of first angular position 201 of rotor element 2 takes place in method 100 as a function of sensor signal 110. Determination 103 of first angular position 201 may take place continuously over angle segments 214, in that sensor signal 110 is continuously sensed and preferably evaluated. A course of sensor signal 110 to first angular position 201 is shown in FIG. 3 over angle segments 214, which each form a subsection 200. Sensor signal 110 repeats over rotational range 210. Based on the design of sensor unit 10, whose measurement range comprises only subsection 200, first angular position 201 is unclear in relation to complete rotational range 210.

In method 100 according to FIG. 1, a sensing 104 of a piece of position information 220 takes place to localize first angular position 201 in rotational range 210. First angular position 201 is localized as a function of sensing 104 of position information 220, in particular in one of angle segments 214. For example, when sensing 104 position information 220, a position signal may be obtained from a further sensor system, and/or piece of position information 220 may be called up from memory unit 21.

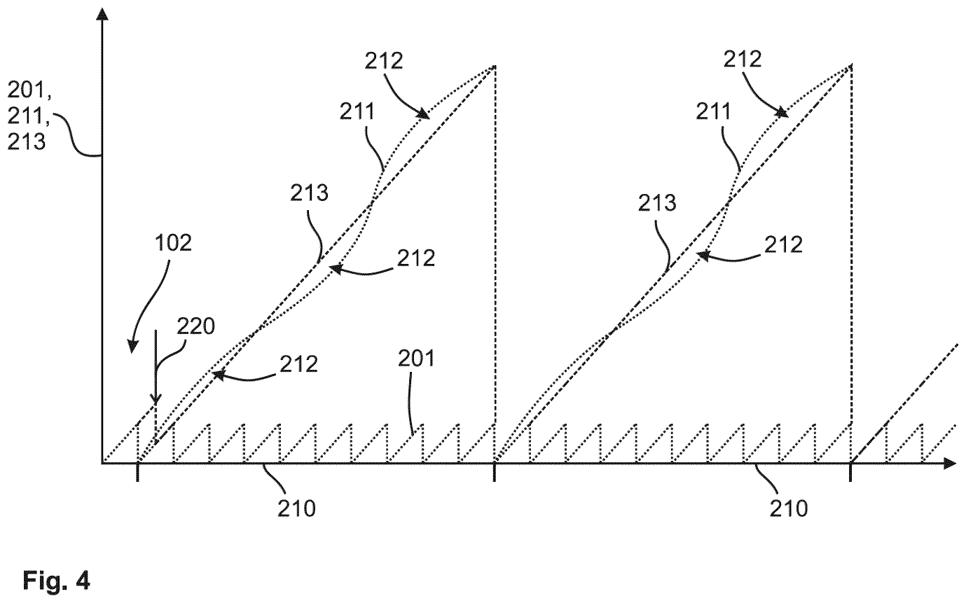

An ascertainment 105 of error information 212.1 of expected angle error 212 subsequently takes place as a function of first angular position 201 and position information 220. As illustrated in FIG. 4, a determination 105.1 of second angular position 211 may preferably be carried out for this purpose, which relates to rotational range 210 of rotor element 2. A course of second angular position 211 may be calculated as a function of angle segments 214 and the course of first angular position 201. Second angular position 211 corresponds, in particular, to the absolute angle, which still has angle error 212, and which rotor element 2 has completed in relation to rotational range 210. As a result, first angular position 201, which is unclear in rotational range 210, becomes, in particular, a clear piece of information in the form of second angular position 211.

In particular, a relation 105.2 of error information 212.1 may be carried out, based on second angular position 211, for the purpose of ascertaining 105 error information 212.1 in database 3. A piece of error information 212.1 of expected angle error 212 may preferably be determined thereby for each first angular position 201 and/or second angular position 211 within rotational range 210.

A determination 106 of rotor position 213 of rotor element 2 relating to rotational range 210 also takes place as a function of error information 212.1 and first angular position 201 and/or second angular position 211. By taking into account angle error 212, rotor position 213 may preferably be defined as an adjusted, absolute rotational position of rotor element 2.

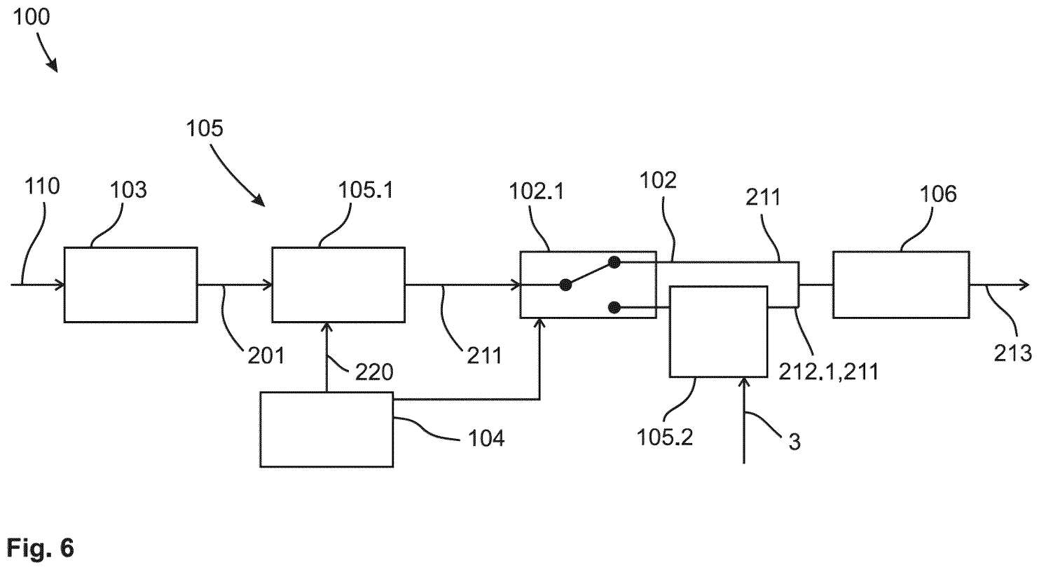

As illustrated in FIG. 6, it may be provided that, up to the sensing 104 of position information 220, an initialization process 102 takes place, in which rotor position 213 is calculated as a function of first angular position 201. Ascertainment 105 of error information 212.1 takes place only by a switchover 102.1 following the completion of initialization process 102 for the purpose of transferring error information 212.1 and/or angle error 212 exclusively to correctly detected angle segments 214.

The accuracy in detecting rotor position 213 may thus be improved beyond subsection 200 by taking into account angle error 212, even though sensor unit 10 is designed only to detect subsection 200. Sensor unit 10 may be provided with a compact and economical design thereby and, at the same time, detect rotor position 213 in the, in particular entire, rotational range 210, taking expected angle error 212 into account. For example, a more precise actuation of rotor element 2 may take place, due to the improved accuracy.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to detecting a rotor position of a rotor element as a function of a sensor signal of a sensor unit to detect a first angular position of the rotor element, which relates to a repeating subsection of a rotation of the rotor element within a rotational range, the method comprising:
determining the first angular position of the rotor element as a function of the sensor signal;
sensing a piece of position information for localizing the first angular position within the rotational range;
ascertaining a piece of error information of an expected angle error as a function of the first angular position and the position information; and
determining the rotor position of the rotor element relating to the rotational range as a function of the error information.

2. The method according to claim 1, wherein, to ascertain the error information as a function of the first angular position and the position information, a second angular position is determined, which relates to the rotational range of the rotor element, and wherein the rotor position is determined as a function of the second angular position.

3. The method according to claim 1, wherein the rotational range is divided into multiple angle segments, the first angular position being localized as a function of the sensing of the position information in one of the angle segments.

4. The method according to claim 1, wherein a sensing of the sensor signal and/or the determination of the first angular position takes place continuously over the angle segments, and wherein a course of the second angular position is determined as a function of the angle segments and a course of the first angular position.

5. The method according to claim 1, wherein, to ascertain the error information, the error information is taken from a database, which comprises multiple entries for the sensor signal and/or the second angular position with a piece of predetermined error information about the angle error assigned in each case.

6. The method according to claim 1, wherein a calibration process is carried out, in which the expected angle error is ascertained over the rotational range, and the pieces of error information are entered into the database.

7. The method according to claim 1, wherein the sensor unit is designed as an inductive sensor, the sensor unit comprising:
a conductor unit, which is rotatably fixedly connected to the rotor element; and
a sensor element for the inductive sensing of the conductor element for detecting the first angular position.

8. The method according to claim 1, wherein the rotational range comprises a complete rotation of the rotor element around a rotation axis, a piece of error information of the expected angle error being able to be determined for each first angular position and/or second angular position within the rotational range.

9. The method according to claim 1, wherein, when sensing the position information, a position signal is obtained from a further sensor system, and/or the position information is called up from a memory unit.

10. The method according to claim 1, wherein, up to the sensing of the position information, an initialization process takes place, in which the rotor position is calculated as a function of the first angular position, the ascertainment of the error information taking place only after the initialization process has been completed.

11. The method according to claim 1, wherein the rotor element is a shaft of a vehicle.

12. A computer program product comprising commands, which, when executed by a control unit, prompt the control unit to carry out the method according to claim 1.

13. A sensor device to detect a rotor position of a rotor element within a rotational range, the sensor device comprising:
a sensor unit for detecting a first angular position of a rotor element, which relates to a subsection of a rotational range of the rotor element; and
a control unit for carrying out the method according to claim 1.
